(19) United States
(12) Patent Application Publication
(10) Pub. No.: US 2026/0140707 A1
(43) Pub. Date: May 21, 2026

(54) DATA QUERY AND NATURAL LANGUAGE QUERY GENERATION AND EVALUATION FOR MULTIPLE USE CASES

(71) Applicant: SAP SE, Walldorf (DE)

(72) Inventors: Yonggang Xie, Singapore (SG); Tao Bai, Singapore (SG); Jo En Chua, Singapore (SG); Li Sheng Jaw, Singapore (SG); De Hui Khoo, Singapore (SG); Yu Sheng Daniel Lee, Singapore (SG); Ting Feng Eugene Lum, Singapore (SG); Jing Xiang Ng, Singapore (SG); Julian Yap, Singapore (SG); GuanZong Zhou, Singapore (SG); Yi Quan Zhou, Singapore (SG)

(21) Appl. No.: 18/953,169

(22) Filed: Nov. 20, 2024

(51) Int. Cl. G06F 8/33; G06F 16/242

(52) U.S. Cl. CPC G06F 8/33; G06F 16/243

(57) ABSTRACT

Methods, systems, and computer-readable storage media for receiving data and data schema metadata, the data schema metadata being descriptive of a data structure and the data being stored in accordance with the data structure, processing the data and the data schema metadata using a set of rules to generate a first data query, prompting a first LLM using a first prompt that includes at least a portion of the first data query to generate a first natural language query, prompting a second LLM using a second prompt that includes at least a portion of the first natural language query to generate a second data query, selectively storing the first natural language query and the second data query as a query pair, and evaluating performance of a ML model using the query pair.

### BACKGROUND

Entities, such as commercial enterprises, use software systems to conduct operations. Example software systems can include, without limitation, enterprise resource management (ERP) systems, customer relationship management (CRM) systems, human capital management (HCM) systems, and the like. Enterprises continuously seek to improve and gain efficiencies in their operations. To this end, enterprises integrate systems in the domain of so-called intelligent enterprise, which can employ artificial intelligence (AI) that can include, for example, machine learning (ML) models. For example, AI can be used for data analytics and/or automating tasks in support of enterprise operations. AI, however, presents technical hurdles and risks that need to be mitigated.

### SUMMARY

Implementations of the present disclosure are directed to a query pair generation and evaluation system that leverages one or more large language models (LLMs) to provide query pair datasets. More particularly, implementations of the present disclosure are directed to a query pair generation and evaluation system that provides rule-based generation of data queries and uses one or more LLMs to provide corresponding natural language queries that are stored as query pair datasets. In some implementations, the query pair datasets are used across multiple use cases, such as benchmarking prompt and/or LLM performance in executing tasks.

In some implementations, actions include receiving data and data schema metadata, the data schema metadata being descriptive of a data structure and the data being stored in accordance with the data structure, processing the data and the data schema metadata using a set of rules to generate a first data query, prompting a first LLM using a first prompt that includes at least a portion of the first data query to generate a first natural language query, prompting a second LLM using a second prompt that includes at least a portion of the first natural language query to generate a second data query, selectively storing the first natural language query and the second data query as a query pair, and evaluating performance of a ML model using the query pair. Other implementations of this aspect include corresponding systems, apparatus, and computer programs, configured to perform the actions of the methods, encoded on computer storage devices.

These and other implementations can each optionally include one or more of the following features: the set of rules includes semantic rules and data type rules, the semantic rules categorizing query filters, the data type rules defining selection of operators and values; categories include determined, undetermined, date, range, and currency; the first prompt and the second prompt each includes context data including at least a portion of the data schema metadata; selectively storing the first natural language query and the second data query as a query pair includes determining that the first data query and the second data query are sufficiently similar, and in response, storing the first natural language query and the second data query as a query pair; determining that the first data query and the second data query are sufficiently similar includes determining that the first data query and the second data query are identical; and the first data query and the second data query are in a structured format includes Javascript object notation (JSON).

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to a query pair generation system that leverages one or more large language models (LLMs) to provide query pair datasets. More particularly, implementations of the present disclosure are directed to a query pair generation and evaluation system that provides rule-based generation of data queries and uses one or more LLMs to provide corresponding natural language queries that are stored as query pair datasets. As described in further detail herein, the query pair generation system provides a two-stage approach for constructing natural language query and data query pairs. In the first stage, a LLM (as an agent generator) is used to generate natural language user queries based on validated data queries. This ensures that the natural language queries are user-friendly and contextually accurate. In the second stage, a LLM (as an agent validator) is used to translate these natural language queries back to data queries, which are compared to the original data queries to verify correctness and relevance. This cross-evaluation technique guarantees that the queries produced are both accurate and operationally effective. In some implementations, the query pairs are used across multiple use cases, such as benchmarking prompt and/or LLM performance in executing tasks.

Implementations can include actions of receiving data and data schema metadata, the data schema metadata being descriptive of a data structure and the data being stored in accordance with the data structure, processing the data and the data schema metadata using a set of rules to generate a first data query, prompting a first LLM using a first prompt that includes at least a portion of the first data query to generate a first natural language query, prompting a second LLM using a second prompt that includes at least a portion of the first natural language query to generate a second data query, selectively storing the first natural language query and the second data query as a query pair, and evaluating performance of a ML model using the query pair.

To provide further context for implementations of the present disclosure, and as introduced above, artificial intelligence (AI) is increasingly being leveraged in applications that support enterprise operations. In the field of AI, so-called generative AI (GAI) has recently seen an explosion in popularity. GAI can be described as including foundation models that generate content based on training data. For example, foundation models can include LLMs, which are a form of GAI that can be used to generate text and perform other functions for a variety of use cases. The increasing power and popularity of GAI has seen enterprises seeking avenues to leverage GAI in improving enterprise operations. However, integrating GAI into enterprise platforms is a non-trivial task. For example, GAI can present various technical challenges, disadvantages, and limitations that have to be managed, which did not exist in the pre-GAI world.

For example, LLMs can be used to convert natural language into a structured format, such as a data query that confirms to a defined data schema. In an example use case, virtual agents (commonly referred to as chatbots) can receive user queries (natural language queries), generate prompts based on the user queries, prompt one or more LLMs using the prompts, and return responses (data (structured) queries) generated by the LLM(s). However, LLMs are provisioned by third-party service providers and are trained on training data from a broad range of domains. In short, LLMs are not domain-specific and, as such, do not perform well when applied to particular domains.

An example domain can include querying resources that maintain and store data that is structured according to a specific data schema, as discussed in further detail herein. In this example domain, a LLM can be prompted to provide a query that can be used to query a resource storing structured data. Here, a LLM can be used to convert a user query (e.g., input to a chatbot in natural language) to an Open Data Protocol (OData) query (a data query that is structured). OData can be described as a standard that defines a structure for querying resources through RESTful application programming interfaces (APIs).

Using a LLM to convert user queries into data queries, such as OData queries, can introduce significant efficiencies in terms of time and technical resources. In general, converting user queries to OData queries can include identifying an entity set referenced in the user query from underlying metadata and generating the OData query based on the entity set and metadata information. However, in generating OData queries, and even when provided with the metadata as context, LLMs frequently misidentify entity sets, particularly in relatively long metadata files, incorrectly assign properties to the entity sets, and struggle to convert natural language values to OData service values. This results in ineffective or unusable OData queries wasting time and technical resources.

These failures occur because LLMs face significant challenges with OData metadata. For example, the metadata can be long, complex, and lacks contextual information. For example, even when a LLM is provided with the metadata as context, the metadata is relatively long and includes metadata that is irrelevant to the user query, which degrades performance of LLMs in generating usable OData queries. As another example, the complicated and overlapping relationships within the metadata make it difficult for LLMs to accurately interpret the data structure. As still another example, the absence of contextual annotations in the metadata limits that ability of the LLMs to understand and process the data accurately.

Further, the performance of LLMs in generating OData queries also depends on the prompts provided to the LLMs. For example, prompts that are absent context data or have relatively sparse context data will result in poor performance of the LLMs in generating OData queries. On the other hand, too much context data can diminish the performance of the LLMs. For example, the more context data, the more time and computing resources the LLM requires for processing and returning a response. Further, LLMs can limit the number of tokens that can be included in prompts, thereby limiting the amount of context data that can be included.

Accordingly, before LLMs can be leveraged for tasks, such as generating structured data queries from unstructured user queries, different LLMs and different prompts need to be evaluated to determine whether a particular prompt and/or a particular LLM can be leveraged for the task. For example, iterations of prompt engineering can be executed for a LLM in an effort to optimize performance and confirm that the prompt and LLM combination can be used for the task. However, the is an absence of evaluation data that can be used to evaluate the performance of prompts and/or LLMs in performing tasks, such as generating structured data queries from unstructured user queries.

In the specific context of OData, OData services are integral to managing data of enterprises in enterprise systems that provide a framework for handling data through web-based protocols. However, due to strict user data privacy and compliance regulations, developers of applications that leverage ML for natural language based Odata querying, face difficulties in accessing valid OData query examples. For example, the absence of comprehensive datasets for training and testing ML models poses a significant barrier. Without these datasets, effective analytic methods for evaluating prompts and models across various OData services cannot be achieved. Traditional data collection methods, which rely heavily on manual effort, are not only labor-intensive but also incur substantial and often prohibitive costs. Furthermore, these conventional approaches lack scalability, making them impractical for meeting the growing demands of ML research and application.

In view of the above context, implementations of the present disclosure provide a query pair generation and evaluation system that leverages one or more LLMs to provide query pair datasets. More particularly, implementations of the present disclosure are directed to a query pair generation and evaluation system that provides rule-based generation of data queries and uses one or more LLMs to provide corresponding natural language queries that are stored as query pair datasets.

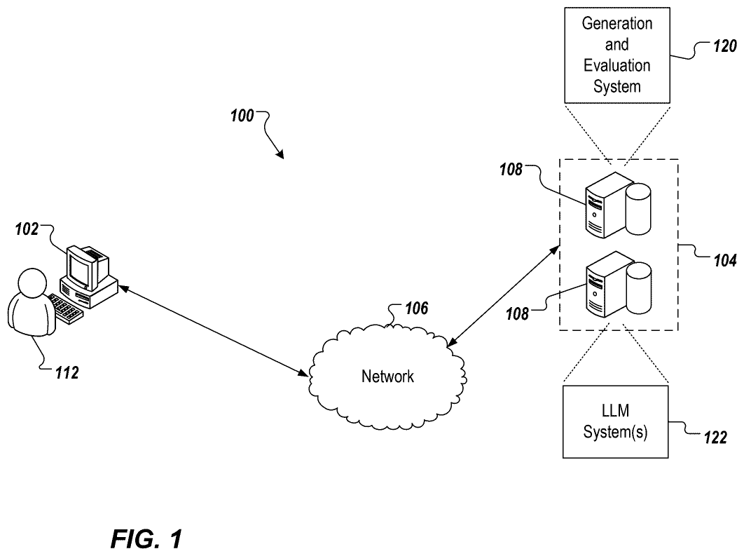

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a query pair generation and evaluation system 120 that leverages one or more LLMs executed by LLM systems 122 to provide query pair datasets. An example LLM can include, without limitation, gpt-3.5-turbo-16 k provided by OpenAI. However, it is contemplated that any appropriate LLM can be used to realize implementations of the present disclosure.

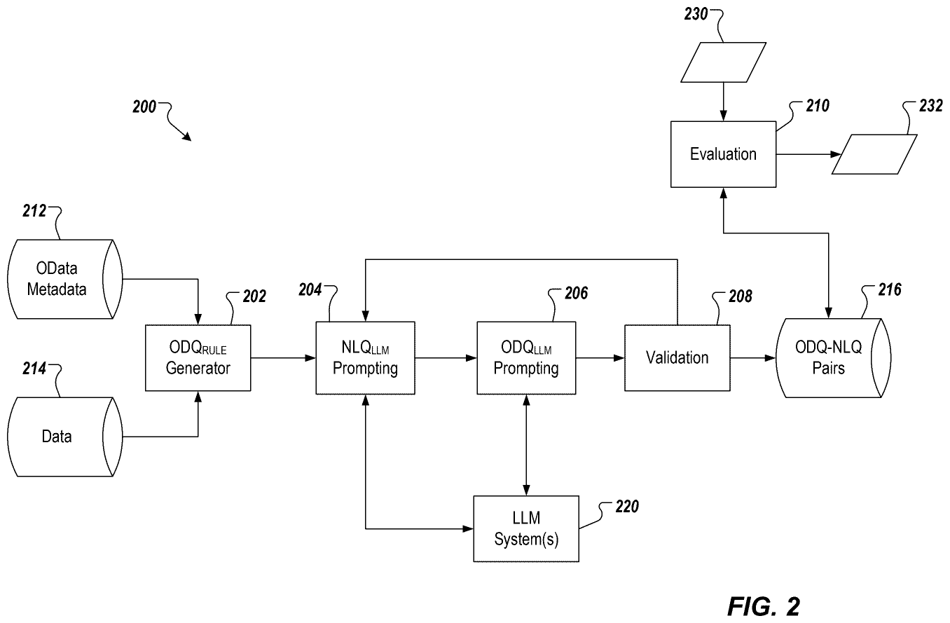

FIG. 2 depicts an example conceptual architecture 200 in accordance with implementations of the present disclosure. In the depicted example, the example conceptual architecture 200 includes a query pair generation and evaluation system (e.g., the query pair generation and evaluation system 120 of FIG. 1) that includes a data query generator 202, a natural language query prompting module 204, a data query prompting module 206, a validation module 208, an evaluation module 210, a data query metadata repository 212, a data repository 214, and a query pair data store 216. As described in further detail herein, the query pair generation and evaluation system leverages one or more LLM systems 220 to provide query pairs that are stored in query pair data store 216. In some examples, the query pairs can be used by the evaluation module 210 to evaluate performance of prompts and/or LLMs.

In further detail, the data query generator 202 processes data query metadata from the data query metadata repository 212 and data from the data repository 214 to provide a data query. In some examples, the data query generator 202 includes a set of rules that are used to provide the data query that conforms to a data structure defined in the data query metadata. For example, the data query can be provided as a rule-based OData query (ODQ_{RULE}).

In some implementations, the set of rules includes semantic rules and data type rules that are used to systematically compose OData query filters for the ODQ_{RULE}. In some examples, using the semantic rules, filters are categorized into types ‘determined’ (e.g., ID, requiring only one filter), ‘undetermined’ (requiring multiple filters to refine data scope), ‘date,’ ‘range,’ and ‘currency.’ In some examples, selection criteria can include, for ‘determined’ types, a single filter is used, for ‘undetermined’ types, multiple filters can be used, ‘currency’ type is selected only if associated with ‘money’ and, for ‘range’ types, appropriate operators are paired to accurately reflect data boundaries. For example, operators like greater than (gt) and less than (lt) define data boundaries. In some examples, the data type governs the choice of operators and values. For example, the data type rules can include that string and Boolean types use the equals (eq) operator, numeric data types (decimal, integer) can use all operators from a set including, for example, eq, lt, gt, and the like, with values formatted accordingly, and date type should use the eq operator and be in correct date or datetime format.

As described herein, the data query generator 202 processes data provided from the data repository 214, which can be provided from an OData server. For purposes illustration, a non-limiting example of data is referenced herein, which includes sales order (SalesOrder) data values. For example:

Listing 1: Example Data Values for SalesOrder

```
  “SalesOrganization”: {
  “type”: “Edm.String”,
    “value”: [
    “4210”,
    “1510”,
    “2910”,
    “6010”,
    “6410”,
    “6510”,
    “3210”,
    “1910”,
    “2010”,
    “7310”,
    “5410”,
    “3010”,
    “2710”,
    “1710”,
    “3110”,
    “5710”
  ]
},
“ShipToParty”: {
  “type”: “Edm.String”,
  “value”: [
    “S29100298”,
    “S25100253”,
    “S62100097”,
    ...
```

A non-limiting example of an ODQ_{RULE} generated by the data query generator 202 can be provided as:

Listing 2: Example ODQ_{RULE}

```
  {
    “idx”: 714,
    “filtercriteria”: {
      “num_filters”: 3,
      “filters”: [
        “DeviationRangeLow”,
        “DeviationRangeLow”,
        “ReferencedSalesOrderID”
      ],
      “operators”: [
        “le”,
        “ge”,
        “eq”
  ],
      “values”: [
        596.0,
        485.0,
        “11111153-aaaa-bbbb-cccc-ddddeeeeffff”
      ]
    },
    “properties_top”: {
      “values”: [
        24
      ]
    },
    “properties_orderby”: {
      “num_filters”: 1,
      “properties”: [
        “ShippingPoint”
      ],
      “order”: [
        “desc”
      ]
    },
    “selectproperties”: {
      “num_filters”: 1,
      “properties”: [
        “SalesOrder”
      ]
    },
  “url”: “https: //sap-ux-mock-services-v4-
alp.cfapps.us10.hana.ondemand.com/sap/opu/odata4/sap/c_salesorder
manage_srv/srvd/sap/c_salesordermanage_sd_aggregate/0001/SalesOrd
erItem?$filter=DeviationRangeLow le 596.0 and DeviationRangeLow
ge 485.0 and ReferencedSalesOrderID eq ‘11111153-aaaa-bbbb-cccc-
ddddeeeeffff’”
  },
```

In further detail, rule-based generation of an ODQ_{RULE} can begin using random selection or user-defined data samples. In some examples, random selection can include randomly selecting a set of properties together with the names, values, and types based on the metadata. Random selection can provide diversity and works with scarce data in the server. In some examples, users can retrieve/manually create some data samples on the server. The set of properties can come from the same piece of data. This ensures that the generated ODQ_{RULE} will return at least one data. This is designed for cases that there is a dedicated downstream application.

In some implementations, for each property, appropriate handling is determined based on data type (e.g., string, boolean, numeric, or datetime). String properties are typically handled with equality comparisons (‘eq’ operator) and the given value. Boolean properties are handled using equality comparisons with lowercase true/false values. Numeric properties have more varied handling (e.g., using greater than or equal to, less than or equal to, exact equality; creating a range query around the given value; adjusting precision of integers or floating-point numbers). Datetime properties, including Date, Datetime, Datetimeoffset, can be handled similarly to numeric properties, but with date-specific logic (e.g., creating queries for dates before, after, or equal to the given date, creating date range queries; ensuring that date ranges do not exceed the current date). For each property, an appropriate filter expression is generated based on its type and the randomly chosen operators. The individual filters are combined into a single query string, typically using ‘and’ as the conjunction between different property filters.

In some implementations, the natural language query (NLQ) prompting module 204 prompts a LLM system (as an agent generator) of the one or more LLM systems 220 to generate a natural language query (NLQ_{LLM}) based on the structured OData filters provided in the ODQ_{RULE}. The NLQ_{LLM} is generated to closely mimic real-world usage scenarios to ensure that the queries are both human-like and relevant to typical user interactions. In some examples, the NLQ prompting module 204 generates a prompt using a prompt template. For example, the prompt template can include static text (e.g., same text for each prompt that is to be generated) and placeholders. In some examples, the static text defines the task that is to be performed by the LLM system (e.g., provide natural language query based on a given data query), constrains the LLM system (e.g., instructing the LLM that its response must be provided in a particular format), and other instructions for processing the prompt. In some examples, the prompt is generated by populating a placeholder with the ODQ_{RULE} and one or more placeholders with context data. Example context data can include data schema metadata (OData metadata) to inform the LLM system of the structure of the ODQ_{RULE}. A portion of example data schema metadata for SalesOrder can be provided as:

Listing 3: Example Metadata for SalesOrder

```
</EntityType>
<EntityType Name=”SalesOrderManageType”>
  <Key>
    <PropertyRef Name+”SalesOrder”/>
  </Key>
  <Property Name+”SalesOrder” Type=”Edm.String”
Nullable=”false” MaxLength=”10”/>
  <Property Name+”SalesOrderType” Type=”Edm.String”
Nullable=”false” MaxLength=”4”/>
  <Property Name+”SoldToParty” Type=”Edm.String”
Nullable=”false” MaxLength=”10”/>
  <Property Name+”CustomerName” Type=”Edm.String”
Nullable=”false” MaxLength=”80”/>
  <Property Name+”SoldToPartyAddressID” Type=”Edm.String”
Nullable=”false” MaxLength=”10”/>
  <Property Name+”SalesOrganization” Type=”Edm.String”
Nullable=”false” MaxLength=”4”/>
...
```

An example NLQ_{LLM} returned by the LLM system 220 can be provided as:

Listing 4: Example NLQ_{LLM}

Can I view the Sales Orders where the lower limit of the accepted
deviation range is less than or equal to 596.0 and greater than
or equal to 485.0, and where the referenced sales order ID is
‘11111153-aaaa-bbbb-cccc-ddddeeeeffff’. Could you please sort the
results by Shipping Point in descending order and only show me
the top 24?

In some implementations, the data query prompting module 206 prompts a LLM system (as an agent validator) of the one or more LLM systems 220 to generate a data query (ODQ_{LLM}) based on the NLQ_{LLM}. In some examples, the data query prompting module 206 the prompts a LLM system that is different from the LLM system that was prompted by the NLQ prompting module 204 to provide the NLQ_{LLM}. In some examples, data query prompting module 206 generates a prompt using a prompt template. In some examples, the prompt is generated by populating a placeholder with the NLQ_{LLM} and one or more placeholders with context data. Example context data can include data schema metadata (OData metadata) to inform the LLM system of the structure expected for the ODQ_{LLM}.

An example prompt that can be used to generate a NLQ_{LLM} can be provided as:

Listing 5: Example Prompt to Generate NLQ_{LLM}

“““
You are given an input filter in json format, containing
filters, operators and values. Generate the corresponding user
querys in human-like natural language. Use a varied tongue for
the query.\
The user query should explicitly cover the filter operators
and values strictly according to the input filter.\
Here are the properties with their descriptions available in
the API docs:
{api_docs}
follow the output instructions strictly, do not include any
other information.\
{output_instructions}\
{filters}
User Query:
”””
api_docs (relevant properties according to filters ) =“““
OverallSDProcessStatus: OverallSDProcessStatus represents the
overall status of a service delivery process. The values in
this column are represented by single letter codes which
correspond to different stages of the process. For example,
‘A’ signifies that the process is ‘Open’, ‘B’ indicates that
the process is ‘In Process', and ‘C’ indicates that the
process is ‘Completed’. A blank value represents ‘Not
Relevant’, suggesting that the process isn't applicable in the
given context.
{‘’: ‘Not Relevant’, ‘A’: ‘Open’, ‘B’: ‘In Process', ‘C’:
‘Completed’}
ShipToParty: ShipToParty represents the unique identifier and
name for the party or company to whom the goods are intended
to be shipped. It combines a unique alphanumeric code for
identification followed by the company name and country of
operation enclosed in parentheses. For instance, ‘S17100197’:
‘TronicTrade Inc. (US)’ signifies that the goods are to be
shipped to TronicTrade Inc. based in the US, with the unique
identification code ‘S17100197’.
{‘S17100197’: ‘TronicTrade Inc. (US)’, ‘S17100253’:
‘TronicTrade Inc. (US)’, ‘S30100197’: ‘Computer Systems (AU)’,
‘S32100197’: ‘Computer Systems (DK)’, ‘S15100197’: ‘Computer
Systems (JP)’, ‘S54100197’: ‘Computer Systems (MY)’,
‘S29100197’: ‘Computer Systems (CA)’, ‘S57100197’: ‘Computer
Systems (PE)’, ‘S42100197’: ‘Computer Systems (IE)’,
‘S73100253’: ‘Domestic EG Customer 4’}
SoldToParty: SoldToParty represents the unique identifier and
name of the company to which products are sold. The column
consists of an alphanumeric value where the first letter ‘S’
is followed by a unique number (identified customer) and the
name of the customer company along with the country code in
brackets. For example, ‘S17100197’: ‘TronicTrade Inc. (US)’,
here ‘S17100197’ is the unique identifier of the customer
‘TronicTrade Inc.’ which is located in the United States (US) .
{‘S17100197’: ‘TronicTrade Inc. (US)’, ‘S17100253’:
‘TronicTrade Inc. (US)’, ‘S30100197’: ‘Computer Systems (AU)’,
‘S32100197’: ‘Computer Systems (DK)’, ‘S15100197’: ‘Computer
Systems (JP)’, ‘S54100197’: ‘Computer Systems (MY)’,
‘S29100197’: ‘Computer Systems (CA)’, ‘S57100197’: ‘Computer
Systems (PE)’, ‘S42100197’: ‘Computer Systems (IE)’,
‘S73100253’: ‘Domestic EG Customer 4’}
”””
output instructions =
“““
Output Formatting Instructions:
Important: Only return the output as a string. Do not include
any additional sentences in the output. Follow the formattting
strictly.
Important: Boolean values (True or False) should be true or
false, all lowercase, without quotes. Numbers should not be
quoted unless they are meant to be strings.
Example 1 (Examples in the prompt for few-shot prompting):
{
“filtercriteria”: {
“filters”: [
“BindingPeriodValidityStartDate”,
“DistributionChannel”
],
“operators”: [
“ge”,
“eq”
],
“values”: [
“2023-12-19”,
“370”
]
},
“properties_top”: {
“values”: [
10
]
},
“properties_orderby”: {
“properties”: [
“RequestedDeliveryDate”
“order”: [
“desc”
]
},
“selectproperties”: {
“properties”: [
“CreatedByUser”,
“SalesOrganizationForFilter”
]
},
}
Possible User Query: Could you please retrieve the sales order
data which are created by users alongside their corresponding
sales organization filters where the distribution channel was
370, and the binding period validity start date was on or
after December 19, 2023? Also, can you please provide this
data in descending order of their requested delivery dates and
only show the top 10 results?
Example 2:
{
“filtercriteria”: {
“filters”: [
“SalesQuotationDate”,
“SalesDocApprovalStatus”
],
“operators”: [
“le”,
“eq”
],
“values”: [
“2023-12-12”,
“C”
]
},
“properties_top”: {
“values”: [ ]
},
“properties_orderby”: {
“properties”: [ ],
“order”: [ ]
},
“selectproperties”: {
“properties”: [ ]
},
}
Possible User Query: “Can you present to me the sales
quotations that were generated on or before the 12th of
December, 2023 and have their approval status as completed?”
filters = {
“filtercriteria”: {
“filters”: [
“OverallSDProcessStatus”,
“TotalPrice”
],
“operators”: [
“eq”,
“gt”
],
“values”: [
“A”,
“300”
]
},
“properties_top”: {
“values”: [5]
},
“properties_orderby”: {
“properties”: [“TotalPrice”],
“order”: [asc]
},
“selectproperties”: {
“properties”: [ ]
},
}
”””

In some implementations, the validation module 208 compares the ODQ_{RULE} to the ODQ_{LLM} to determine whether they are sufficiently similar. In some examples, the validation module 208 compares the ODQ_{RULE} to the ODQ_{LLM} to determine whether they are identical (e.g., only difference in order of the filter criteria lists is acceptable). In the evaluation, the lists are sorted to the same order for exact comparison. If the ODQ_{RULE} and the ODQ_{LLM} are not sufficiently similar (e.g., identical), the data query prompting module 206 modifies the prompt and again prompts the LLM system to provide a NLQ_{LLM} that is used to generate a ODQ_{LLM}, which is compared to the ODQ_{RULE} by the validation module 208. This can be repeated until the ODQ_{RULE} and the ODQ_{LLM} are sufficiently similar (e.g., identical). In some examples, in response to determining that the ODQ_{RULE} and the ODQ_{LLM} are sufficiently similar (e.g., identical), the NLQ_{LLM} and the ODQ_{LLM} are stored as a query pair in the query pair data store 216.

In some implementations, the query pair generation and evaluation system can generate numerous (e.g., tens, hundreds, thousands) query pairs to populate the query pair data store 216.

In some implementations, the evaluation module 210 uses query pairs stored in the query pair data store 216 for one or more use cases. For example, the evaluation module 210 can receive input 230, can process the input 230 in view of one or more query pairs, and can provide output 232.

An example use case can include fine-tuning an OData-specific ML model. For example, the query pairs can be used to train and tailor the ML model for OData-related tasks. For example, a user can use natural language to ask queries to an LLM to retrieve the sales order information, after which a card will be created to display the order information. Here, the dataset of paired user queries (NLQ_{LLM}) and corresponding filter criteria (ODQ_{LLM}) for retrieving sales order information can be used to improve the accuracy of processing natural language input to retrieve sales order information. For example, the NLQ_{LLM} queries can be used as the input 216 to a model by the evaluation module 210, which returns the output 232. In this example, the ODQ_{LLM} filter criteria can be used to evaluate the accuracy of the sales order data that is returned. The model and/or prompt to the model can be iteratively adjusted to improve the results returned by the model. This enables performance of the application in interpreting user queries to be improved and getting accurate data for displaying sales order information.

Another example use case can include benchmarking ML models with OData tasks. For example, while traditional benchmarks assess ML models on various tasks like coding, summarization, and translation, the query pairs can be used to benchmark ML models for OData-specific tasks. Another example use case can include iterative prompt engineering for OData tasks. For example, by analyzing evaluation results from the dataset, developers can continuously improve and optimize prompts for OData-related tasks. Still another example use case includes enhancing OData solutions. For example, developers can leverage evaluation outcomes using the query pairs to refine and redesign OData-based solutions, improving overall performance and functionality.

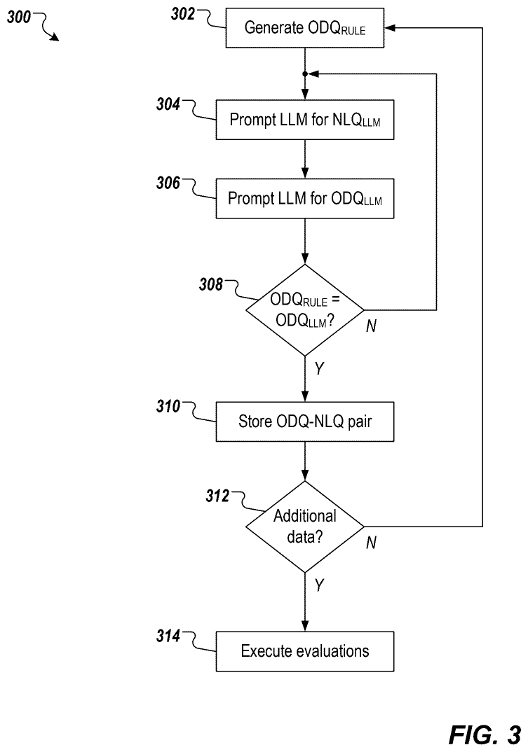

FIG. 3 depicts an example process 300 that can be executed in accordance with implementations of the present disclosure. In some examples, the example process 300 is provided using one or more computer-executable programs executed by one or more computing devices.

A data query (ODQ_{RULE}) is generated (302). For example, and as described herein, the data query generator 202 processes data query metadata from the data query metadata repository 212 and data from the data repository 214 to provide a data query (ODQ_{RULE}). A LLM is prompted to generate a natural language query (NLQ_{LLM}) (304). For example, and as described herein, the natural language query (NLQ) prompting module 204 prompts a LLM system (as an agent generator) of the one or more LLM systems 220 to generate a natural language query (NLQ_{LLM}) based on the structured OData filters provided in the ODQ_{RULE}. A LLM is prompted to generate a data query (ODQ_{LLM}) (306). For example, and as described herein, the data query prompting module 206 prompts a LLM system (as an agent validator) of the one or more LLM systems 220 to generate a data query (ODQ_{LLM}) based on the NLQ_{LLM}.

The ODQ_{RULE} and the ODQ_{LLM} are compared (308). For example, and as described herein, the validation module 208 compares the ODQ_{RULE} to the ODQ_{LLM} to determine whether they are sufficiently similar. In some examples, the validation module 208 compares the ODQ_{RULE} to the ODQ_{LLM} to determine whether they are identical. If the ODQ_{RULE} and the ODQ_{LLM} are not sufficiently similar, the example process 300 loops back to modify the prompt and generate another NLQ_{LLM} and ODQ_{LLM}. This loop can be repeated until the ODQ_{RULE} and the ODQ_{LLM} are sufficiently similar.

If the ODQ_{RULE} and the ODQ_{LLM} are sufficiently similar, the NLQ_{LLM} and ODQ_{LLM} query pair are stored (310). For example, and as described herein, the NLQ_{LLM} and the ODQ_{LLM} are stored as a query pair in the query pair data store 216. It is determined whether additional data is to be generated (312). For example, query pairs can be generated until a threshold number of query pairs have been generated and stored. If additional data is to be generated, the example process 300 loops back. If no additional data is to be generated, one or more evaluations are executed (314). For example, and as described herein, the evaluation module 210 uses query pairs stored in the query pair data store 216 for one or more use cases.

As described herein, generating query pairs in accordance with implementations of the present disclosure provides multiple advantages and technical improvements. For example, implementations of the present disclosure enables the creation of custom datasets ([NLQ_{LLM}, ODQ_{LLM}] query pairs) tailored to specific needs, ensuring that all relevant scenarios are covered. For example, rare or edge cases, can be synthesized to comprehensively evaluate performance of ML models. With a synthetic dataset, it can be ensured that all ML models are benchmarked on the same data in a comprehensive way, allowing for fair and objective comparison. Further, the use of synthetic data mitigates privacy concerns and complies with data protection regulations, as no real personal information is used. This also avoids ethical issues associated with using sensitive or proprietary real-world data. Synthetic data also enables developers to bypass restrictions associated with real data. By utilizing synthesized datasets, developers can freely build and test applications without the limitations imposed by access to real-world datasets. This not only protects personal data, but also expands the scope and speed of innovation in application development. Also, query pair generation in accordance with implementations of the present disclosure provides for generalizable OData query generation based on semantic refinement and data types. This facilitates the creation and evaluation of OData-related ML/AI applications by generating robust OData queries that are scalable and adaptable across different systems.

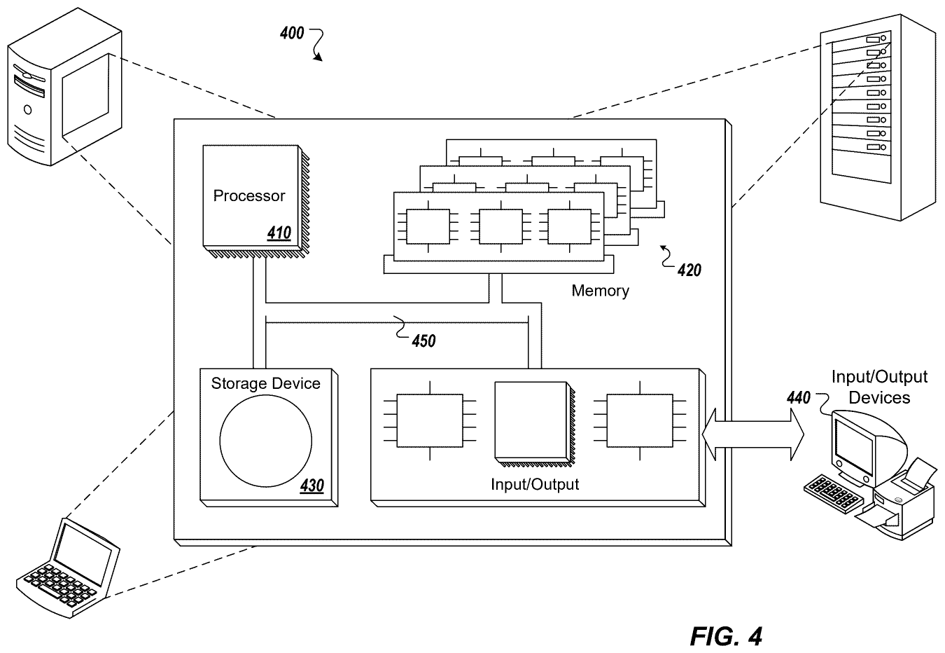

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for developing applications leveraging machine learning (ML) models, the method being executed by one or more processors and comprising:
receiving data and data schema metadata, the data schema metadata being descriptive of a data structure and the data being stored in accordance with the data structure;
processing the data and the data schema metadata using a set of rules to generate a first data query;
prompting a first large language model (LLM) using a first prompt that comprises at least a portion of the first data query to generate a first natural language query;
prompting a second LLM using a second prompt that comprises at least a portion of the first natural language query to generate a second data query;
selectively storing the first natural language query and the second data query as a query pair; and
evaluating performance of a ML model using the query pair.

2. The method of claim 1, wherein the set of rules comprises semantic rules and data type rules, the semantic rules categorizing query filters, the data type rules defining selection of operators and values.

3. The method of claim 2, wherein categories comprise determined, undetermined, date, range, and currency.

4. The method of claim 1, wherein the first prompt and the second prompt each comprises context data comprising at least a portion of the data schema metadata.

5. The method of claim 1, wherein selectively storing the first natural language query and the second data query as a query pair comprises determining that the first data query and the second data query are sufficiently similar, and in response, storing the first natural language query and the second data query as a query pair.

6. The method of claim 5, wherein determining that the first data query and the second data query are sufficiently similar comprises determining that the first data query and the second data query are identical.

7. The method of claim 1, wherein the first data query and the second data query are in a structured format comprising Javascript object notation (JSON).

8. A non-transitory computer-readable storage medium coupled to one or more processors and having instructions stored thereon which, when executed by the one or more processors, cause the one or more processors to perform operations for developing applications leveraging machine learning (ML) models, the operations comprising:
receiving data and data schema metadata, the data schema metadata being descriptive of a data structure and the data being stored in accordance with the data structure;
processing the data and the data schema metadata using a set of rules to generate a first data query;
prompting a first large language model (LLM) using a first prompt that comprises at least a portion of the first data query to generate a first natural language query;
prompting a second LLM using a second prompt that comprises at least a portion of the first natural language query to generate a second data query;
selectively storing the first natural language query and the second data query as a query pair; and
evaluating performance of a ML model using the query pair.

9. The non-transitory computer-readable storage medium of claim 8, wherein the set of rules comprises semantic rules and data type rules, the semantic rules categorizing query filters, the data type rules defining selection of operators and values.

10. The non-transitory computer-readable storage medium of claim 9, wherein categories comprise determined, undetermined, date, range, and currency.

11. The non-transitory computer-readable storage medium of claim 8, wherein the first prompt and the second prompt each comprises context data comprising at least a portion of the data schema metadata.

12. The non-transitory computer-readable storage medium of claim 8, wherein selectively storing the first natural language query and the second data query as a query pair comprises determining that the first data query and the second data query are sufficiently similar, and in response, storing the first natural language query and the second data query as a query pair.

13. The non-transitory computer-readable storage medium of claim 12, wherein determining that the first data query and the second data query are sufficiently similar comprises determining that the first data query and the second data query are identical.

14. The non-transitory computer-readable storage medium of claim 8, wherein the first data query and the second data query are in a structured format comprising Javascript object notation (JSON).

15. A system, comprising:
a computing device; and
a computer-readable storage device coupled to the computing device and having instructions stored thereon which, when executed by the computing device, cause the computing device to perform operations for developing applications leveraging machine learning (ML) models, the operations comprising:
receiving data and data schema metadata, the data schema metadata being descriptive of a data structure and the data being stored in accordance with the data structure;
processing the data and the data schema metadata using a set of rules to generate a first data query;
prompting a first large language model (LLM) using a first prompt that comprises at least a portion of the first data query to generate a first natural language query;
prompting a second LLM using a second prompt that comprises at least a portion of the first natural language query to generate a second data query;
selectively storing the first natural language query and the second data query as a query pair; and
evaluating performance of a ML model using the query pair.

16. The system of claim 15, wherein the set of rules comprises semantic rules and data type rules, the semantic rules categorizing query filters, the data type rules defining selection of operators and values.

17. The system of claim 16, wherein categories comprise determined, undetermined, date, range, and currency.

18. The system of claim 15, wherein the first prompt and the second prompt each comprises context data comprising at least a portion of the data schema metadata.

19. The system of claim 15, wherein selectively storing the first natural language query and the second data query as a query pair comprises determining that the first data query and the second data query are sufficiently similar, and in response, storing the first natural language query and the second data query as a query pair.

20. The system of claim 19, wherein determining that the first data query and the second data query are sufficiently similar comprises determining that the first data query and the second data query are identical.
